(19) United States
(12) Patent Application Publication
(10) Pub. No.: US 2025/0225028 A1
(43) Pub. Date: Jul. 10, 2025

(54) ADAPTIVE ERROR HANDLING FOR A WIDE RANGE OF HIGH-RELIABILITY ERROR RATES

(71) Applicant: Micron Technology, Inc., Boise, ID (US)

(72) Inventors: Mustafa N. Kaynak, San Diego, CA (US); Sivagnanam Parthasarathy, Carlsbad, CA (US)

(21) Appl. No.: 18/977,022

(22) Filed: Dec. 11, 2024

Related U.S. Application Data
(60) Provisional application No. 63/619,558, filed on Jan. 10, 2024.

(51) Int. Cl. G06F 11/10

(52) U.S. Cl. CPC G06F 11/1048; G06F 11/1016

(57) ABSTRACT

A first decoding parameter is obtained responsive to the determining that the codeword contains errors. The first decoding parameter includes a first likelihood set and a first transformation set. A decoding operation with the first decoding parameter is performed. A second decoding parameter is obtained responsive to determining that the decoding operation did not correct the errors of the codeword. The second decoding parameter includes a second likelihood set and a second transformation set. The decoding operation with the second decoding parameter is performed.

### RELATED APPLICATIONS

This application claims the benefit of U.S. Provisional Paten Application No. 63/619,558, filed Jan. 10, 2024, which is incorporated by reference herein.

### TECHNICAL FIELD

Embodiments of the disclosure relate generally to memory sub-systems, and more specifically, relate to adaptive error handling for a wide range of high-reliability error rates.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example computing system that includes a memory sub-system in accordance with some embodiments of the present disclosure.

FIG. 1B illustrates a block diagram of a memory device in communication with a memory sub-system in accordance with some embodiments of the present disclosure.

FIG. 2 is a high-level flow diagram of an example method for adaptive error handling for a wide range of high-reliability error rates, in accordance with some embodiments of the present disclosure.

FIG. 3 is a high-level flow diagram of an example method for adaptive error handling for a wide range of high-reliability error rates, in accordance with some embodiments.

FIG. 4 is a block diagram of an example computer system in which embodiments of the present disclosure may operate.

### DETAILED DESCRIPTION

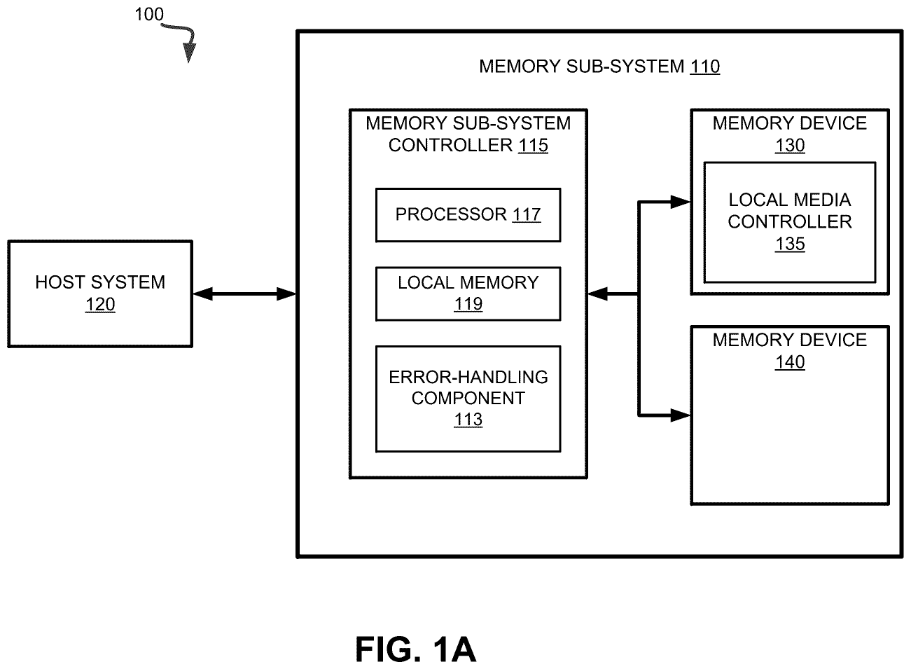

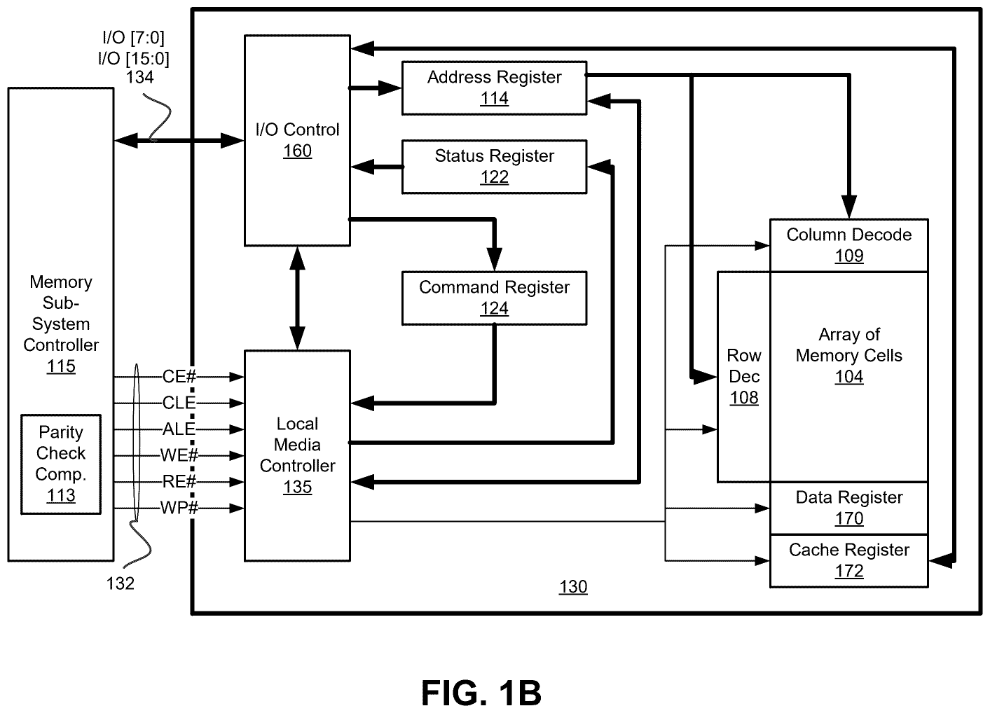

Aspects of the present disclosure are directed to adaptive error handling for a wide range of high-reliability error rates. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND memory devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple cells arranged in a two-dimensional or a three-dimensional grid. Memory cells can be formed onto a silicon wafer in an array of columns connected by conductive lines (also hereinafter referred to as bitlines, or BLs) and rows connected by conductive lines (also hereinafter referred to as wordlines or WLs). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. One example of a memory sub-system is a solid-state drive (SSD) that includes one or more non-volatile memory devices and a memory sub-system controller to manage the non-volatile memory devices.

The memory sub-system controller can encode the host and other data, as part of a write operation, into a format for storage at the memory device(s). Encoding refers to a process of generating using an error detection and correcting code (ECC) parity bits from user data (e.g., a sequence of binary bits) and combining the parity bits to the user data to generate a codeword. Low density parity check (LDPC) encoding refers to an encoding method that utilizes an LDPC code to generate parity bits. The LDPC code is defined by, among other things, a sparse parity-check matrix. Each row embodies a linear constraint imposed on a designated subset of data bits. Entries within the matrix, either 0 or 1, signify the participation of individual data bits in each constraint. In other words, each row represents a parity-check equation, and each column corresponds to a bit in the codeword. During encoding, the user data is multiplied by the sparse parity-check matrix associated with a chosen LDPC code to generate parity bits. The generated parity bits are appended to the user data to generate a LPDC codeword. The LDPC codeword includes with the user data embedded redundancy within the parity bits, allowing for identification and rectification of errors. The LDPC codeword, as noted above can be stored at the memory device(s).

The memory sub-system controller can decode codewords, as part of a read operation, stored at the memory device(s). Decoding refers to a process of reconstructing the original user data (e.g., sequence of binary bits) from the codeword (e.g., the encoded original user data) received from storage at the memory device(s). LDPC decoding refers to a decoding method that utilizes the LDPC code to reconstruct the original user data. Initially, during LDPC decoding, the LDPC codeword is compared with the expected relationships encoded in the parity-check matrix. In particular, the LDPC codeword is multiplied by a transpose of the parity-check matrix associated with the LDPC code used to encode the LDPC codeword. The result of the multiplication produces a vector (e.g., a syndrome vector), in which each element corresponds to a specific parity-check equation in the sparse parity-check matrix. A zero value within the vector signifies that the corresponding parity-check equation is satisfied (e.g., no errors or having even number of bit errors in the parity check equation), and a non-zero value indicates potential errors affecting the bits involved in the corresponding parity-check equation. Potential errors, for example, may be due to the bits involved in the corresponding parity-check equation being flipped due to noise, interference, distortion, bit synchronization errors, or errors from the media itself (both intrinsic and extrinsic). For example, a bit that may have originally been stored as a 0 may be flipped to a 1 or vice versa.

In response to the potential errors, an algorithm of the LDPC decoding, such as a min-sum algorithm, iteratively analyzes the LPDC codeword and estimate the most likely values for the data bits. In particular, the algorithm of the LDPC decoding (e.g., decoding algorithm) is initialized with either hard decisions and/or soft decisions of the LDPC codeword. Hard decisions refer to binary decisions made about the LDPC codeword, where each bit is classified as either ‘0’ or ‘1’ based on a threshold. Soft decisions refer a likelihood or confidence score indicating how likely each bit is to be classified as either ‘0’ or ‘1’. In some instances, soft decisions may be represented as a log-likelihood ratio (LLR) set, in which each LLR of the LLR set is a value that indicates a likelihood or confidence score a bit of the LDPC codeword to be classified as either ‘0’ or ‘1’. Each LLR is defined as a logarithm of a likelihood ratio. The likelihood ratio is a ratio of the probabilities of receiving a particular signal given the bit is ‘0’ versus the bit being ‘1’ or vice versa. A positive LLR (e.g., a positive value) indicates that ‘0’ is a more likely decision, whereas a negative LLR (e.g., a negative value) indicates that ‘1’ is a more likely decision. The magnitude of the LLR indicates the confidence in this decision. A higher magnitude (or larger value) suggests higher confidence in the decision.

Once the decoding algorithm is initialized with either hard decisions or soft decisions of the LDPC codeword. The decoding algorithm, using a tanner graph, iteratively exchanges messages within the tanner graph. The tanner graph refers to a bipartite graph representation of the LDPC code's sparse parity-check matrix. The tanner graph includes two types of nodes: variable nodes (representing the bits of the codeword) and check nodes (representing the parity-check equations). Each check node is connected to several variable nodes. The decoding algorithm iteratively exchanges messages within the tanner graph by iteratively exchanges messages between variable nodes and check nodes.

With respect to the decoding algorithm initialized with hard decisions, during each iteration, each check node sends a message to each connected variable node based the hard decisions. The messages are based on the initialized hard decisions made. That is, the messages indicate a definite ‘0’ or ‘1’. The variable nodes update their values based on these hard decision messages, and this process repeats iteratively. The decoding algorithm iterates, with each node updating its value based on the incoming messages until it converges to a stable set of values that satisfy the parity-check equations of the LDPC code's sparse parity-check matrix, or until a maximum number of iterations is reached. This decoder can be considered as a hard decision decoder.

With respect to the decoding algorithm initialized with soft decisions, during each iteration, each check node computes and sends a message to each connected variable node based the soft decisions. The message reflects the likelihood of that particular bit satisfying the corresponding parity-check equation, given the current estimates of the other bits, based on the initialized soft decisions, involved in that parity check. Each connected variable node, based on the message computed by the corresponding check node, updates their estimate, i.e., LLR. Each connected variable node sends back an updated message to the check node, which influences the next message from the check node. This iterative process gradually refines the estimates of each bit's likelihood, aiming to converge to a consistent set of values that satisfy all parity-check equations of the LDPC code's sparse parity-check matrix, or until a maximum number of iterations is reached. The use of soft decisions in the decoding algorithm is computationally more complex than the hard decisions in the decoding algorithm, but generally results in more accurate decoding (e.g., increased reliability of the error-correction capability).

Codeword error rate (CWER) is a metric used to quantify the correction capability of the decoding algorithm. In other words, CWER reflects the number of codewords out of a collection of codewords that have at least one bit error after the decoding process. A lower CWER implies better decoding performance and higher reliability, while a higher CWER suggests that the algorithm may struggle to effectively correct errors. With respect to using hard information with the decoding algorithm, CWER is functionally dependent on the raw-bit-error-rate (RBER), which is a raw measure of errors occurring in the absence of any correction.

With respect to using soft information with the decoding algorithm, CWER is functionally dependent on the RBER and high reliability error rate (HRER), which measures the reliability of bits marked as “highly reliable” by the soft input. More specifically, HRER quantifies the error rate among bits identified as “highly reliable” based on soft information. Accordingly, for a given RBER, an increase in the HRER leads to an increase in the CWER. This relationship suggests that when more errors are falsely assigned high reliability values, it becomes more challenging for the decoding algorithm to correctly reconstruct the original codewords, thus leading to a higher CWER.

Additionally, LDPC codes come in two main types based on the column weight (CW), which is the number of parity bits each codeword bit interacts with. Regular LDPC codes have a fixed CW for all codeword bits, while irregular LDPC codes allow for varying CWs. A high readability error bit impacts CW number of parity checks and hence different types of LDPC codes-whether regular or irregular and CW distribution-are impacted differently by HRER and, consequently, the CWER is a function of HRER and LDPC type. Accordingly, decoders may require specific optimizations to handle different types of LDPC codes and HRER levels to maximize error-correction capabilities.

Aspects of the present disclosure address the above and other deficiencies by providing a memory sub-system controller that iteratively performs a decoding algorithm with various parameters to compensate for various HRERs. In some embodiments, the memory sub-system controller maintains a plurality of LLR sets, each of LLR set of the plurality of LLR set represents a predefined LLR sets for a specific range of HRER (e.g., low range, medium range, or high range). Each LLR set of the plurality of LLR sets represents an optimal or near optimal (herein referred to as optimal) LLR set for the specific range of HRER (e.g., optimal LLR sets). In some embodiments, the optimal (or near optimal) LLR set is determined by performing, during or after manufacturing, information analysis on voltage threshold distribution at various stress conditions resulting in a specific HRER range. As previously described, each LLR set (e.g., likelihood set) includes a plurality of LLR values (e.g., likelihood values). The memory sub-system controller maintains, in addition the plurality of LLR sets, a plurality of transformation sets, each transformation set of the plurality of transformation sets represent a predefined transformation sets for a specific range of HRER (e.g., low range, medium range, or high range). Each transformation set provides a scalar value and an offset value to be applied to the LLR set during the decoding algorithm. Each transformation set of the plurality of transformation sets represents an optimal transformation set for the specific range of HRER. In other words, the plurality of LLR sets (e.g., an LLR array) and the plurality of transformation sets (e.g., a transformation array) are defined during manufacturing and stored at the memory device(s). Each transformation set corresponds to different scenarios of how much confidence the decoder puts on the information passed from check nodes to variable nodes, i.e., whether the decoder needs to be more or less conservative on using this information. These transformation sets can be optimized based on software simulations corresponding to different RBER and HRER regions that represent various stress conditions.

The memory sub-system controller receives a codeword sent over a communication channel. The memory sub-system controller calculates a syndrome vector which indicates that the codeword includes errors. The memory sub-system controller iteratively selects a permutation of an LLR set from the LLR array and a transformation from the transformation array and performs the decoding algorithm with the selected permutation. For example, each permutation may be selected by starting with a first LLR set of the LLR array and a first transformation set of the transformation array. Each transformation set of the transformation array is selected to be paired with a current LLR set of the LLR array, before proceeding to the next LLR set of the LLR array. The process is repeated for each LLR set of the LLR array until a last LLR set of the LLR array.

The memory sub-system controller initializes the decoding algorithm with the selected permutation and performs the decoding algorithm. More specifically, variable nodes are initialized with the LLR set of the permutation. After the first iteration, the LLR set is updated using the transformations by applying the scalar and offset value to each LLR of the LLR set of the permutation (e.g., multiplying the scalar value by the LLR and adding the offset value). The process is then repeated until a set of values that satisfy all parity-check equations, or until a maximum number of iterations is reached. If the decoding algorithm fails to correct the error, the memory sub-system controller repeats the decoding algorithm with a different permutation selected from the LLR array and the transformation array until the decoding algorithm corrects the error or until each possible unique permutation from the LLR array and the transformation array is used.

Advantages of the present disclosure include, but are not limited to, increasing the correction capability of the decoding algorithm for various HRER values and LDPC codes, thereby increasing the reliability, performance, and longevity of the memory sub-system.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115, for example, may employ a Flash Translation Layer (FTL) to translate logical addresses to corresponding physical memory addresses, which can be stored in one or more FTL mapping tables. In some instances, the FTL mapping table can be referred to as a logical-to-physical (L2P) mapping table storing L2P mapping information. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

In at least one embodiment, memory sub-system 110 may include an error-handling component 113 that retries a decoding algorithm with various combinations of LLR sets and transformations to compensate for each range of HRER. In some embodiments, the memory sub-system controller 115 includes at least a portion of the error-handling component 113. In some embodiments, the error-handling component 113 is part of the host system 120, an application, or an operating system. In other embodiments, local media controller 135 includes at least a portion of error-handling component 113 and is configured to perform the functionality described herein.

In some embodiment, the error-handling component 113 determines that a codeword (e.g., LDPC codeword) read from memory device 130 and/or 140 contains some bit errors. The error-handling component 113 may obtain a decoding parameter to be used in performing a decoding algorithm. The decoding parameter an LLR set selected from the LLR array and a transformation selected from the transformation array. As previously described, each permutation may be selected by starting with a first LLR set of the LLR array and a first transformation set of the transformation array. Each transformation set of the transformation array is selected to be paired with a current LLR set of the LLR array, before proceeding to the next LLR set of the LLR array. The process is repeated for each LLR set of the LLR array until a last LLR set of the LLR array. In some embodiments, a permutation may be randomly selected from the LLR array and the transformation array.

The error-handling component 113 initializes the decoding algorithm with a LLR set of the decoding parameter and performs the decoding algorithm. More specifically, variable nodes are initialized with the LLR set of the decoding parameters, referred to as initial LLRs denoted as Lᵢₙᵢₜ. These initial LLRs are then used in an iterative process, exchanging messages between variable nodes and associated check nodes. For example, if a variable node V is connected to three check nodes C1, C2, and C3, messages m_{C1}→V, m_{C2}→V, and m_{C3}→V (i.e., each of which represents the message that is passed from check node to variable node) would be computed based on existing LLRs and specific rules, often involving the minimum of LLRs. As an example assuming scalar value denoted as “s” and offset value denoted as “o”, m_{C1}→V=s*min1(or min 2)+o where min1 and min2 correspond to smallest/second smallest LLR to check node C1. After the first iteration, the LLR for V would be updated using the formula and the transformation set of decoding parameters (e.g., L_{new}=(Lᵢₙᵢₜ)+m_{C1}→V+m_{C1}→V +m_{C1}→V). The process is then repeated for a set number of iterations or until certain conditions are met, using the updated L_{new} as the starting point for the next round. Finally, a hard decision is made based on the resulting L_{final}; if L_{final}>0, the bit is decoded as ‘1’, and if L_{final} <0, it is decoded as ‘0’. This iterative mechanism allows for more effective error correction by continually updating the LLRs.

If the decoding algorithm is unable to correctly decode the codeword, the error-handling component 113 selects obtains a subsequent decoding parameter to be used in performing the decoding algorithm. As previously described, the subsequent decoding parameter is obtained by varying the LLR set and/or the transformation set. The error-handling component 113 initializes the decoding algorithm with a LLR set of the subsequent decoding parameter and performs the decoding algorithm. With each iteration of the decoding algorithm, as previously described, the LLR is updated using the transformation set of the subsequent decoding parameter. The decoding algorithm is then repeated for a set number of iterations or until certain conditions are met.

In other words, the error-handling component 113 iteratively obtains new decoding parameters, initializes the decoding algorithm with a LLR set of the newly obtained decoding parameter, and performs the decoding algorithm updating LLR values with a transformation of the newly obtained decoding parameter until the decoding algorithm correctly decodes the codeword or each possible permutation of the LLR set from the LLR array and the transformation set of the transformation array is used as a decoding parameter utilized in the decoding algorithm (e.g., each possible decoding parameter). If each possible decoding parameter is utilized in the decoding algorithm and the decoding algorithm is unable to correctly decode the codeword, the error handling component 113 flags the codeword as unreliable or erroneous.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses.

The local media controller 135 is also in communication with a cache register 172. Cache register 172 latches data, either incoming or outgoing, as directed by the local media controller 135 to temporarily store data while the array of memory cells 104 is busy writing or reading, respectively, other data. During a program operation (e.g., write operation), data may be passed from the cache register 172 to the data register 170 for transfer to the array of memory cells 104; then new data may be latched in the cache register 172 from the I/O control circuitry 160. During a read operation, data may be passed from the cache register 172 to the I/O control circuitry 160 for output to the memory sub-system controller 115; then new data may be passed from the data register 170 to the cache register 172. The cache register 172 and/or the data register 170 may form (e.g., may form a portion of) a page buffer of the memory device 130. A page buffer may further include sensing devices (not shown in FIG. 1B) to sense a data state of a memory cell of the array of memory cells 104, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE#, a command latch enable signal CLE, an address latch enable signal ALE, a write enable signal WE#, a read enable signal RE#, and a write protect signal WP#. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 236 and outputs data to the memory sub-system controller 115 over I/O bus 236.

For example, the commands may be received over input/output (I/O) pins [7:0] of I/O bus 236 at I/O control circuitry 160 and may then be written into command register 124. The addresses may be received over input/output (I/O) pins [7:0] of I/O bus 236 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 172. The data may be subsequently written into data register 170 for programming the array of memory cells 104.

In an embodiment, cache register 172 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

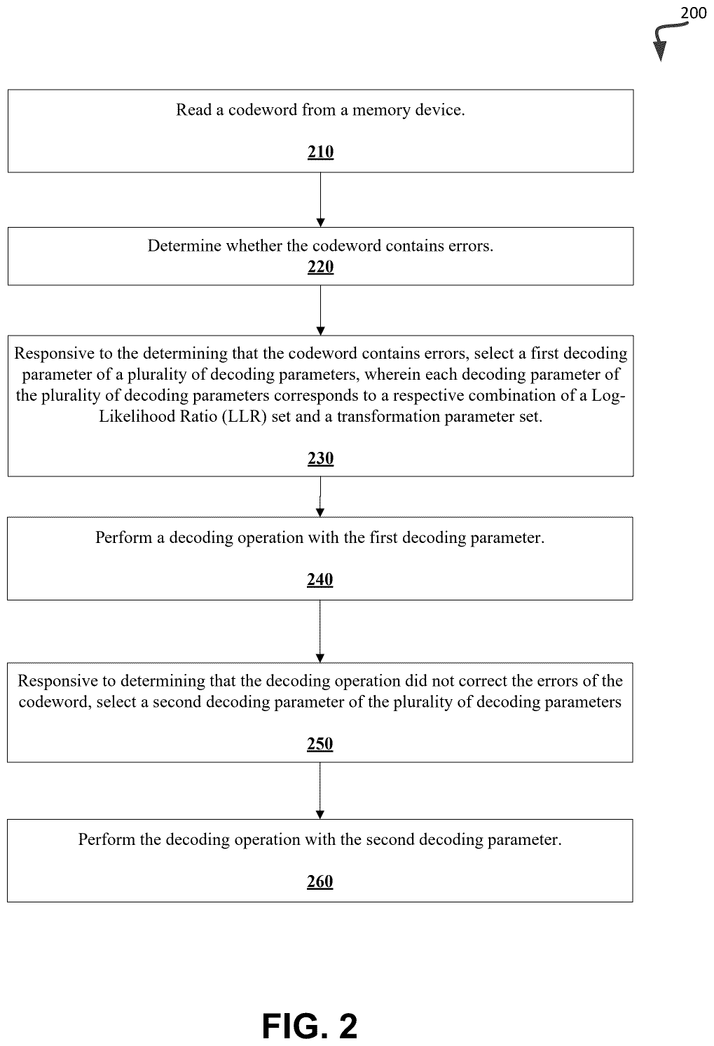

FIG. 2 is a flow diagram of an example method of adaptive error handling for a wide range of high-reliability error rates in a memory sub-system in accordance with some embodiments of the present disclosure. Method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by error-handling component 113 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 210, the processing device reads a codeword from a memory device. As previously described, the codeword refers to host data encoded using a predefined matrix and written to physical memory cells of the memory device. At operation 220, the processing device determines whether the codeword contains errors. In some embodiments, the processing device may determine that the codeword contains errors by multiplying the codeword with the predefined matrix used to encode the host data.

At operation 230, responsive to the determining that the codeword contains errors, the processing device obtains a first decoding parameter. The first decoding parameter includes a first likelihood set and a first transformation set. As previously described, each decoding parameter (e.g., first decoding parameter) is obtained by selecting an LLR set (e.g., a first likelihood set) from a LLR array (i.e., an array of likelihood sets) and selecting a transformation set (e.g., a first transformation set) from a transformation array. In some embodiments, each decoding parameter may be selected by starting with a first LLR set of the LLR array and a first transformation set of the transformation array. Each transformation set of the transformation array is selected to be paired with a current LLR set of the LLR array, before proceeding to the next LLR set of the LLR array. The process is repeated for each LLR set of the LLR array until a last LLR set of the LLR array. In some embodiments, a permutation may be randomly selected from the LLR array and the transformation array.

At operation 240, the processing device performs a decoding operation with the first decoding parameter. As previously described, variable nodes are initialized with the LLR set of the first decoding parameters (e.g., a first likelihood set). Then an iterative process exchanging messages between variable nodes and associated check nodes is performed. After the first iteration, the LLR for variable nodes would be updated using the formula and the transformations of first decoding parameters. In particular, the message (i.e., LLR) that is sent from the check node to the variable node is multiplied by the scalar value of the transformation set (e.g., first transformation set) and an offset value of the transformation is added. The process is then repeated for a set number of iterations or until certain conditions are met. Finally, a hard decision is made based on the results.

At operation 250, responsive to determining that the decoding operation did not correct the errors of the codeword, the processing device obtains a second decoding parameter. The second decoding parameter includes a second likelihood set and a second transformation set. In some embodiments, the first likelihood set of the first decoding parameter is different from the second likelihood set of the second decoding parameter and/or the first transformation set of the first decoding parameter is different from the second transformation set of the second decoding parameter. As previously described, each decoding parameter (e.g., second decoding parameter) is obtained by selecting an LLR set (e.g., a second likelihood set) from a LLR array (i.e., an array of likelihood sets) and selecting a transformation set (e.g., a second transformation set) from a transformation array. In some embodiments, each decoding parameter may be selected by starting with a first LLR set of the LLR array and a first transformation set of the transformation array. Each transformation set of the transformation array is selected to be paired with a current LLR set of the LLR array, before proceeding to the next LLR set of the LLR array. The process is repeated for each LLR set of the LLR array until a last LLR set of the LLR array. In some embodiments, a permutation may be randomly selected from the LLR array and the transformation array.

At operation 260, the processing logic performs a decoding operation with the second decoding parameter. As previously described, variable nodes are initialized with the LLR set of the second decoding parameters (e.g., the second likelihood set). Then an iterative process exchanging messages between variable nodes and associated check nodes is performed. After the first iteration, the LLR for variable nodes would be updated using the formula and the transformations of first decoding parameters. In particular, the message (i.e., LLR) that is sent from the check node to the variable node is multiplied by the scalar value of the transformation set (e.g., second transformation set) and an offset value of the transformation is added. The process is then repeated for a set number of iterations or until certain conditions are met. Finally, a hard decision is made based on the results.

In some embodiments, responsive to determining that the decoding operation did not correct the errors of the codeword, the processing device determines whether a subsequent decoding parameter can be obtained. Responsive to determining that a subsequent decoding parameter can be obtained, the processing device obtains a third decoding parameter of the plurality of decoding parameters. The third decoding parameter includes a third likelihood set and a third transformation set. In some embodiments, the third likelihood set may be different from the first likelihood set and/or the second likelihood set. In some embodiments, the third transformation set may be different from the first transformation set and/or the second transformation set of the second decoding parameter. The processing device performs the decoding operation with the third decoding parameter.

As previously described, each decoding parameter (e.g., third decoding parameter) is obtained by selecting an LLR set (e.g., a third likelihood set) from a LLR array (i.e., an array of likelihood sets) and selecting a transformation set (e.g., a second transformation set) from a transformation array. In some embodiments, each decoding parameter may be selected by starting with a first LLR set of the LLR array and a first transformation set of the transformation array. Each transformation set of the transformation array is selected to be paired with a current LLR set of the LLR array, before proceeding to the next LLR set of the LLR array. The process is repeated for each LLR set of the LLR array until a last LLR set of the LLR array. In some embodiments, a permutation may be randomly selected from the LLR array and the transformation array.

Depending on the embodiment, responsive to determining that the decoding operation did not correct the errors of the codeword, determining whether a subsequent decoding parameter can be obtained. Responsive to determining that a subsequent decoding parameter cannot be obtained, flagging the codeword as unreliable. As previously described, since each decoding parameter may be selected by starting with a first LLR set of the LLR array and a first transformation set of the transformation array, the transformation set is varied until a last transformation set, and repeated for each subsequent LLR set of the LLR array. Accordingly, the last LLR set and the last transformation set represents the last decoding parameter that can be obtained. After that the processing device determines that no subsequent decoding parameter can be obtained.

Depending on the embodiment, responsive to determining that the decoding operation corrected the errors of the codeword, returning the codeword. In other words, after each decoding operation, the codeword is checked for errors using the predefined matrix. If the codeword is decoded without any errors, the codeword is returned to a requestor and no further decoding operations are performed.

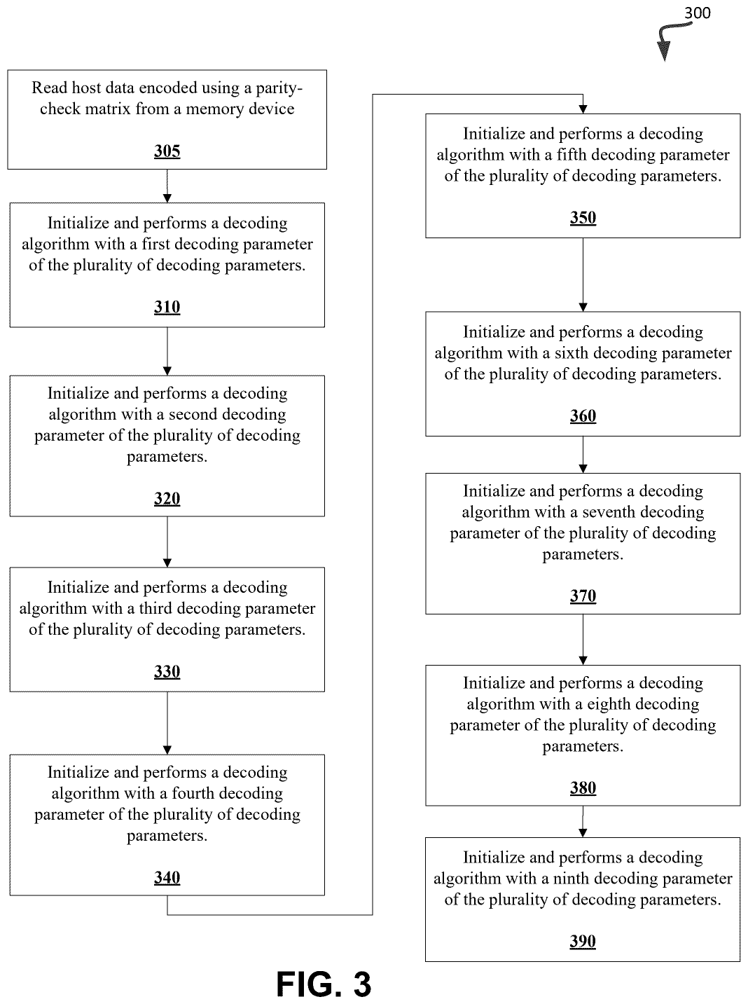

FIG. 3 is a flow diagram of an example method of adaptive error handling for a wide range of high-reliability error rates in a memory sub-system in accordance with some embodiments of the present disclosure. Method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 300 is performed by error-handling component 113 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing logic reads a codeword. Responsive to reading the codeword, the processing logic determines whether the codeword, using a parity check matrix, includes one or more errors. Responsive to determining that the codeword includes one or more errors, the processing logic identifies one or more LLR sets (e.g., LLR set 1, LLR set 2, and LLR set 3) and one or more transformation sets (e.g., TP set 1, TP set 2, and TP set 3). As noted above, each LLR set (e.g., LLR set 1) includes optimal LLR values for a predefined range of HRER (e.g., low range, medium range, or high range). As noted above, each transformation set provides an optimal scalar value and an optimal offset value for a predefined range of HRER (e.g., low range, medium range, or high range).

In some embodiments, the processing logic may obtain a decoding parameter based on a permutation of the a LLR set of the LLR sets and the a transformation set of the transformation sets (e.g., LLR set 1/TP set 1, LLR set 1/TP set 2, LLR set 1/TP set 3, LLR set 2/TP set 1, LLR set 2/TP set 2, LLR set 3/TP set 3, LLR set 3/TP set 1, LLR set 3/TP set 2, and LLR set 3/TP set 3). As noted above, each decoding parameter may vary the transformation set then the LLR set, the LLR set then the transformation set, or both the LLR set and the transformation set, randomly.

At operation 310, the processing logic initializes a decoding algorithm with a LLR set of a first decoding parameter (e.g., LLR set 1/TP set 1) and performs the decoding algorithm. More specifically, variable nodes are initialized with the LLR set of the first decoding parameter (e.g., LLR set 1), which is then used in an iterative process where messages are exchanged between variable nodes and associated check nodes. After each iteration, the LLR for variable node (V) would be updated using a formula, as noted above, and the transformations of the first decoding parameter (e.g., a scalar and offset value of TP set 1). Then, after the last iteration, a hard decision is made based on the resulting LLRs (e.g., greater than 0 decoded as ‘1’ and less than 0 decoded as ‘1’). Responsive to the decoding algorithm correctly decoding the codeword, the processing logic returns the host data associated with the codeword. Otherwise, the processing logic proceeds to operation 320.

At operation 320, the processing logic, initializes the decoding algorithm with a LLR set of a second decoding parameter (e.g., LLR set 1/TP set 2) and during performance of the decoding algorithm updates LLRs each iteration using the transformation set of the second decoding parameter (e.g., a scalar and offset value of TP set 2). Then, after the last iteration, a hard decision is made based on the resulting LLRs (e.g., greater than 0 decoded as ‘1’, and less than 0 decoded as ‘1’). Responsive to the decoding algorithm correctly decoding the codeword, the processing logic returns the host data associated with the codeword. Otherwise, the processing logic proceeds to operation 330.

At operation 330, the processing logic initializes the decoding algorithm with a LLR set of a second decoding parameter (e.g., LLR set 1/TP set 3) and during performance of the decoding algorithm updates LLRs each iteration using the transformation set of the second decoding parameter (e.g., a scalar and offset value of TP set 3). Then, after the last iteration, a hard decision is made based on the resulting LLRs (e.g., greater than 0 decoded as ‘1’, and less than 0 decoded as ‘1’). Responsive to the decoding algorithm correctly decoding the codeword, the processing logic returns the host data associated with the codeword. Otherwise, the processing logic proceeds to operation 340.

At operation 340, the processing logic initializes the decoding algorithm with a LLR set of a second decoding parameter (e.g., LLR set 2/TP set 1) and during performance of the decoding algorithm updates LLRs using the transformation set of the second decoding parameter (e.g., a scalar and offset value of TP set 1). Then, after the last iteration, a hard decision is made based on the resulting LLRs (e.g., greater than 0 decoded as ‘1’, and less than 0 decoded as ‘1’). Responsive to the decoding algorithm correctly decoding the codeword, the processing logic returns the host data associated with the codeword. Otherwise, the processing logic proceeds to operation 350.

At operation 350, the processing logic initializes the decoding algorithm with a LLR set of a second decoding parameter (e.g., LLR set 2/TP set 2) and during performance of the decoding algorithm updates LLRs using the transformation set of the second decoding parameter (e.g., a scalar and offset value of TP set 2). Then, after the last iteration, a hard decision is made based on the resulting LLRs (e.g., greater than 0 decoded as ‘1’, and less than 0 decoded as ‘1’). Responsive to the decoding algorithm correctly decoding the codeword, the processing logic returns the host data associated with the codeword. Otherwise, the processing logic proceeds to operation 360.

At operation 360, the processing logic initializes the decoding algorithm with a LLR set of a second decoding parameter (e.g., LLR set 2/TP set 3) and during performance of the decoding algorithm updates LLRs using the transformation set of the second decoding parameter (e.g., a scalar and offset value of TP set 3). Then, after the last iteration, a hard decision is made based on the resulting LLRs (e.g., greater than 0 decoded as ‘1’, and less than 0 decoded as ‘1’). Responsive to the decoding algorithm correctly decoding the codeword, the processing logic returns the host data associated with the codeword. Otherwise, the processing logic proceeds to operation 370.

At operation 370, the processing logic initializes the decoding algorithm with a LLR set of a second decoding parameter (e.g., LLR set 3/TP set 1) and during performance of the decoding algorithm updates LLRs using the transformation set of the second decoding parameter (e.g., a scalar and offset value of TP set 1). Then, after the last iteration, a hard decision is made based on the resulting LLRs (e.g., greater than 0 decoded as ‘1’, and less than 0 decoded as ‘1’). Responsive to the decoding algorithm correctly decoding the codeword, the processing logic returns the host data associated with the codeword. Otherwise, the processing logic proceeds to operation 380.

At operation 380, the processing logic initializes the decoding algorithm with a LLR set of a second decoding parameter (e.g., LLR set 3/TP set 2) and during performance of the decoding algorithm updates LLRs using the transformation set of the second decoding parameter (e.g., a scalar and offset value of TP set 2). Then, after the last iteration, a hard decision is made based on the resulting LLRs (e.g., greater than 0 decoded as ‘1’, and less than 0 decoded as ‘1’). Responsive to the decoding algorithm correctly decoding the codeword, the processing logic returns the host data associated with the codeword. Otherwise, the processing logic proceeds to operation 390.

At operation 390, the processing logic initializes the decoding algorithm with a LLR set of a second decoding parameter (e.g., LLR set 2/TP set 1) and during performance of the decoding algorithm updates LLRs using the transformation set of the second decoding parameter (e.g., a scalar and offset value of TP set 1). Then, after the last iteration, a hard decision is made based on the resulting LLRs (e.g., greater than 0 decoded as ‘1’, and less than 0 decoded as ‘1’). Responsive to the decoding algorithm correctly decoding the codeword, the processing logic returns the host data associated with the codeword. Otherwise, the processing logic proceeds to operation. Otherwise, the processing logic flags the codeword as unreliable or erroneous.

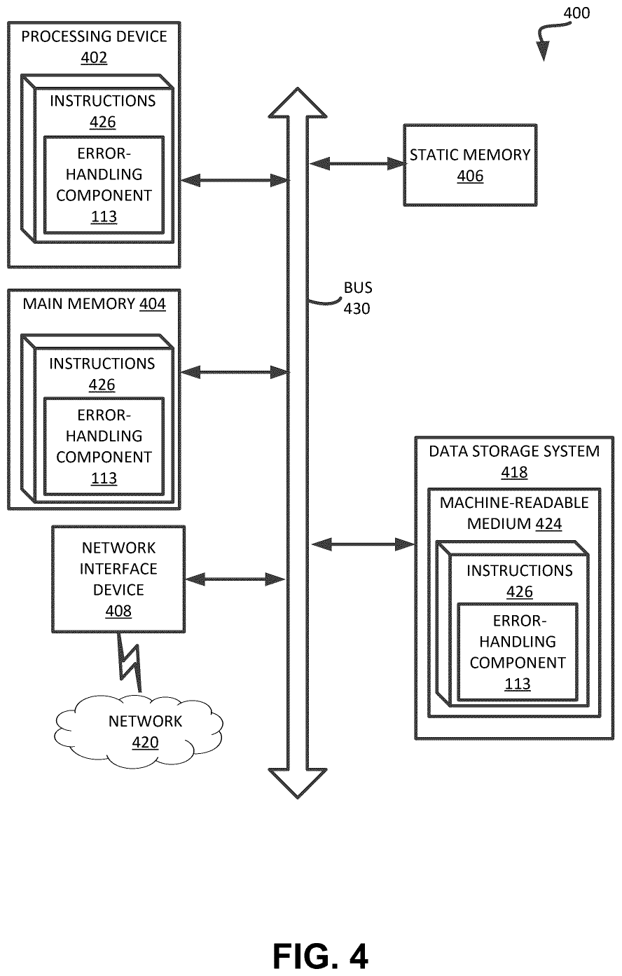

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the error-handling component 113 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1A.

In one embodiment, the instructions 426 include instructions to implement functionality corresponding to the error-handling component 113 of FIG. 1A). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

What is claimed is:

1. A method comprising:
reading, by a processing device, a codeword from a memory device;
determining whether the codeword contains errors; and
responsive to the determining that the codeword contains errors, obtaining a first decoding parameter, wherein the first decoding parameter includes a first likelihood set and a first transformation set;
performing a decoding operation with the first decoding parameter;
responsive to determining that the decoding operation did not correct the errors of the codeword, obtaining a second decoding parameter, wherein the second decoding parameter includes a second likelihood set and a second transformation set; and
performing the decoding operation with the second decoding parameter.

2. The method of claim 1, wherein the first likelihood set of the first decoding parameter is different from the second likelihood set of the second decoding parameter or the first transformation set of the first decoding parameter is different from the second transformation set of the second decoding parameter.

3. The method of claim 2, wherein the first transformation set and the second transformation set includes a scalar value and an offset value and corresponds to a range of high reliability error rate (HRER) values.

4. The method of claim 2, wherein each likelihood set includes a plurality of likelihood values and corresponds to a range of high reliability error rate (HRER) values.

5. The method of claim 1, further comprising:
responsive to determining that the decoding operation did not correct the errors of the codeword, determining whether a subsequent decoding parameter can be obtained;
responsive to determining that a subsequent decoding parameter can be obtained, obtaining a third decoding parameter, wherein the third decoding parameter includes a third likelihood set and a third transformation set; and
performing the decoding operation with the third decoding parameter.

6. The method of claim 1, further comprising:
responsive to determining that the decoding operation did not correct the errors of the codeword, determining whether a subsequent decoding parameter can be obtained;
responsive to determining that a subsequent decoding parameter can not be obtained, flagging the codeword as unreliable.

7. The method of claim 1, further comprising:
responsive to determining that the decoding operation corrected the errors of the codeword, returning the codeword.

8. A system comprising:
a memory device; and
a processing device coupled to the memory device, the processing device to perform operations comprising:
reading, by a processing device, a codeword from a memory device;
determining whether the codeword contains errors; and
responsive to the determining that the codeword contains errors, obtaining a first decoding parameter, wherein the first decoding parameter includes a first likelihood set and a first transformation set;
performing a decoding operation with the first decoding parameter;
responsive to determining that the decoding operation did not correct the errors of the codeword, obtaining a second decoding parameter, wherein the second decoding parameter includes a second likelihood set and a second transformation set; and
performing the decoding operation with the second decoding parameter.

9. The system of claim 8, wherein the first likelihood set of the first decoding parameter is different from the second likelihood set of the second decoding parameter or the first transformation set of the first decoding parameter is different from the second transformation set of the second decoding parameter.

10. The system of claim 9, wherein the first transformation set and the second transformation set includes a scalar value and an offset value and corresponds to a range of high reliability error rate (HRER) values.

11. The system of claim 9, wherein each likelihood set includes a plurality of likelihood values and corresponds to a range of high reliability error rate (HRER) values.

12. The system of claim 8, wherein the processing device is to perform operations further comprising:
responsive to determining that the decoding operation did not correct the errors of the codeword, determining whether a subsequent decoding parameter can be obtained;
responsive to determining that a subsequent decoding parameter can be obtained, obtaining a third decoding parameter, wherein the third decoding parameter includes a third likelihood set and a third transformation set; and
performing the decoding operation with the third decoding parameter.

13. The system of claim 8, wherein the processing device is to perform operations further comprising:
responsive to determining that the decoding operation did not correct the errors of the codeword, determining whether a subsequent decoding parameter can be obtained;
responsive to determining that a subsequent decoding parameter can not be obtained, flagging the codeword as unreliable.

14. The system of claim 8, wherein the processing device is to perform operations further comprising:
responsive to determining that the decoding operation corrected the errors of the codeword, returning the codeword.

15. A non-transitory computer-readable storage medium comprising instructions that, when executed by a processing device, cause the processing device to perform operations comprising:
reading, by a processing device, a codeword from a memory device;
determining whether the codeword contains errors; and
responsive to the determining that the codeword contains errors, obtaining a first decoding parameter, wherein the first decoding parameter includes a first likelihood set and a first transformation set;
performing a decoding operation with the first decoding parameter;
responsive to determining that the decoding operation did not correct the errors of the codeword, obtaining a second decoding parameter, wherein the second decoding parameter includes a second likelihood set and a second transformation set; and
performing the decoding operation with the second decoding parameter.

16. The non-transitory computer-readable storage medium of claim 15, wherein the first likelihood set of the first decoding parameter is different from the second likelihood set of the second decoding parameter or the first transformation set of the first decoding parameter is different from the second transformation set of the second decoding parameter.

17. The non-transitory computer-readable storage medium of claim 15, wherein the first transformation set and the second transformation set includes a scalar value and an offset value and corresponds to a range of high reliability error rate (HRER) values; and wherein each likelihood set includes a plurality of likelihood values and corresponds to a range of high reliability error rate (HRER) values.

18. The non-transitory computer-readable storage medium of claim 15, wherein the processing device is to perform operations further comprising:
responsive to determining that the decoding operation did not correct the errors of the codeword, determining whether a subsequent decoding parameter can be obtained;
responsive to determining that a subsequent decoding parameter can be obtained, obtaining a third decoding parameter, wherein the third decoding parameter includes a third likelihood set and a third transformation set; and
performing the decoding operation with the third decoding parameter.

19. The non-transitory computer-readable storage medium of claim 15, wherein the processing device is to perform operations further comprising:
responsive to determining that the decoding operation did not correct the errors of the codeword, determining whether a subsequent decoding parameter can be obtained;
responsive to determining that a subsequent decoding parameter can not be obtained, flagging the codeword as unreliable.

20. The non-transitory computer-readable storage medium of claim 15, wherein the processing device is to perform operations further comprising:
responsive to determining that the decoding operation corrected the errors of the codeword, returning the codeword.
